(19) United States
(12) Patent Application Publication
(10) Pub. No.: US 2013/0269593 A1
(43) Pub. Date: Oct. 17, 2013

(54) System and Method Used to Identify and Protect Utility Lines

(71) Applicant: DeLee Leon Upchurch, II, Arlington, TN (US)

(72) Inventor: DeLee Leon Upchurch, II, Arlington, TN (US)

(21) Appl. No.: 13/447,133

(22) Filed: Apr. 13, 2012

(51) Int. Cl. G01D 21/00; H02G 1/06; H01B 13/34

(52) U.S. Cl. 116/209; 29/428; 29/527.2

(57) ABSTRACT

A system used to detect and identify at least one utility line is disclosed. The system comprises an indicator applied to the outside surface of a utility line. The indicator surrounds at least a majority of the outside surface of the utility line and creates a protective barrier around the utility line. In one embodiment, the indicator comprises a polyurethane foam. In another embodiment, the indicator is a sleeve. A color coding system used to identify at least one underground utility line is also disclosed. A method used to identify at least one underground utility line is also needed to detect and identify at least one underground utility line is also disclosed.

### FIELD

The present invention relates generally to a system and method used to identify and protect underground utilities. More specifically, the present invention relates to an indicator, such as a polyurethane foam or foam sleeve, applied to utility lines to identify and protect such utility lines once buried underground. The indicator may be applied to the utility lines upon initial installation or upon any exposure of such utility lines during excavation or construction.

### BACKGROUND

Public utility systems often run underground, some by the nature of their function and others for convenience or aesthetics. Public utility systems include utility lines for telephones, electricity distribution, natural gas, cable television, fiber optics, traffic lights, street lights, storm drains, water mains, and wastewater pipes. In some locations, public utility systems compete for underground space with major oil and gas pipelines, national defense communication lines, mass transit, and rail and road tunnels.

Prior to any construction or excavation at any job site, it is critical and often mandatory to identify and temporarily mark public utility systems. Public utility systems are usually marked with colored lines or colored flags above ground. Marking utility lines prevents accidental breakage of the underground utilities from shovel or tractor which often results in major utility outages or serious accidents, or an evacuation due to a gas leak.

Studies have shown that an underground utility is hit or damaged every sixty seconds. The result may have minor consequences or major consequences such as the loss of emergency 911 communications or other vital services, and in extreme cases, serious injuries and loss of life. When such serious consequences occur, damage claims and lawsuits develop. Damage to underground utilities costs billions of dollars in damage each year. As utility easements become more crowded, preventing damage to underground utilities becomes increasingly challenging. Below ground, our public rights-of-way have become a spider web of utility lines including electric, gas, telephone, fiber optic, cable television and water mains, sewers and storm drains. As mentioned above at some underground locations, the web of utility lines may also include national defense communication lines, mass transit tunnels, railroad tunnels and major oil and high-pressure gas pipelines.

Locating and marking underground utilities is often difficult and imprecise, and thus, utility lines are susceptible to damage during excavations, drillings and construction. Maps of underground utility systems may exist but often lack the pinpoint precision needed to ensure accurate marking which ensures proper clearance of utility lines. And, in some instances, the maps may be inaccurate or even non existent. Moreover, “live” utility lines may not be shown on the official “as built” plans resulting in service utility lines being presumed “dead” but are actually “live”. The ability to determine the physical location, nature and depth of existing underground utility lines is critical to reduce the risk and consequences of inadvertent damage during construction.

A worst case scenario occurred in St. Cloud, Minn. in December 1998. A cable construction company installing a utility pole struck and ruptured a one-inch diameter, high-pressure, plastic gas service pipeline. Less than an hour after the rupture, an explosion occurred resulting in significant damage including the death of four people and the destruction of six buildings.

Utility companies often provide location and detection services of utility lines to construction workers at construction sites prior to any excavation or building. Such location and detection services are usually mandatory (by local government) and require the construction workers to contact the utility company. Upon contact, the utility company travels to the construction site and identifies or marks where the underground utilities are located via color coding the existing underground utilities. Colored lines and/or flags may be used to identify the location and denote the type of underground utility. Failure to contact a utility company for such services is considered negligence and may result in a fine or even a criminal charge against the construction workers or company involved.

Utility color codes are presently used in construction areas to temporarily identify the approximate location of existing underground utilities. The American Public Works Association (APWA) Uniform Color Codes for temporary marking of underground utilities is the following: red is used to mark electric power lines, cables, conduit and lighting cables; orange is used to mark telecommunication, alarm or signal lines, cables, or conduit; yellow is used to mark natural gas, oil, steam, petroleum, or other gaseous or flammable material; green is used to mark sewers and drain lines; blue is used to mark drinking water; violet is used to mark reclaimed water, irrigation, and slurry lines; pink is used to mark temporary survey markings, unknown/unidentified facilities; and white is used to mark proposed excavation limits or route.

Although utility color codes and other methods of detection exist to identify underground utilities, such methods are often inaccurate. Beginning excavation or any construction based on inaccurate markings of underground utilities often results in damage to the underground utilities and may result in injury or even death to the construction worker.

Accordingly, a system and method used to accurately detect and identify underground utilities to prevent damage to such underground utilities and injury to persons is needed.

### BRIEF SUMMARY

A system and method used to detect and identify underground utilities is disclosed. The system comprises an indicator which is applied to the outside surface of a utility line. The indicator may be applied to a utility line upon initial installation of the utility line, or the indicator may be applied to a utility line upon subsequent exposure of such utility line. The indicator surrounds at least a majority of the outside surface of the utility line and creates a protective barrier around a majority of the outside surface of the utility line before the utility line is buried underground. In one embodiment, the indicator may be a polyurethane foam. In another embodiment, the indicator may be a sleeve. In one embodiment, the indicator applied to the utility line may be a particular color depending on the type of utility line to which such indicator is applied. In a further embodiment, the indicator expands about at least one inch around the outside surface of the utility line.

A system used to identify a plurality of underground utility lines is also disclosed. The system comprises an indicator which is applied to the outside surface of each of the plurality of utility lines. The indicator may be applied to the utility lines upon initial installation of the utility lines, or the indicator may be applied to the utility lines upon any exposure of such utility lines. The indicator surrounds at least a majority of the outside surface of each of the utility lines and creates a protective barrier around each of the utility lines before the utility lines are buried underground. In one embodiment, the indicator may be a polyurethane foam. In another embodiment, the indicator may be a sleeve. In one embodiment, the indicator applied to the utility lines may be a particular color depending on the type of utility line to which such indicator is applied. In a further embodiment, the indicator expands about at least one inch around a majority of the outside surface of the utility lines.

A method used to identify at least one underground utility line is also disclosed. In one embodiment, the method comprises the following steps: (a) applying an indicator to the outside surface of the utility line and (b) burying the utility line underground. In one embodiment, the indicator surrounds at least a majority of the outside surface of the utility line. In another embodiment, the indicator creates a protective barrier around at least a majority of the outside surface of the utility line. In one embodiment, step (a) comprises applying an indicator comprising a polyurethane foam. In another embodiment, step (a) comprises applying an indicator comprising a sleeve. In a further embodiment, the indicator applied to the utility line may be a particular color dependent on the type of utility line. In still a further embodiment, the indicator may expand about one inch around a majority of the outside surface of the utility line.

### BRIEF DESCRIPTION OF THE DRAWINGS

The present disclosure will be better understood by reference to the following detailed description when considered in conjunction with the accompanying drawing wherein:

FIG. 1A is a perspective view of a system used to detect and identify at least one utility line in accordance with an exemplary embodiment of the present invention.

FIG. 1B is a perspective view of the system used to detect and identify at least one utility line of FIG. 1A wherein the indictor has not been applied.

FIG. 1C is a perspective view of the system of FIG. 1A wherein the indicator has been applied to the utility line and wherein the indicator is a color dependent on the type of utility line.

FIG. 1D is a perspective view of an utility line with indicator applied, wherein the indicator is a color dependent on the type of utility line and wherein the indicator is partially applied to a utility line in accordance with an exemplary embodiment of the present invention.

FIG. 2A a perspective view of a system used to detect and identify a plurality of utility lines in accordance with another exemplary embodiment of the present invention.

FIG. 2B is a perspective view of the system used to detect and identify a plurality of utility lines of FIG. 2A wherein the indicator has not been applied to the plurality of utility lines.

FIG. 2C is a perspective view of the system of FIG. 2A wherein the indicator has been applied to the plurality of utility lines and wherein the indicator on each utility line is a color dependent on the type of utility line.

FIG. 2D is a perspective view of a plurality of utility lines with indicator applied, wherein the indicator is a color dependent on the type of utility line and wherein the indicator is partially applied to a plurality of utility lines.

FIG. 3A is a perspective view of a system used to detect and identify at least one utility line in accordance with a further exemplary embodiment of the present invention.

FIG. 3B is a perspective view of an indicator of FIG. 3A.

FIG. 3C is a perspective view of an indicator according to another exemplary embodiment of the present invention.

FIG. 3D is a perspective view of an indicator according to a further exemplary embodiment of the present invention.

### DETAILED DESCRIPTION

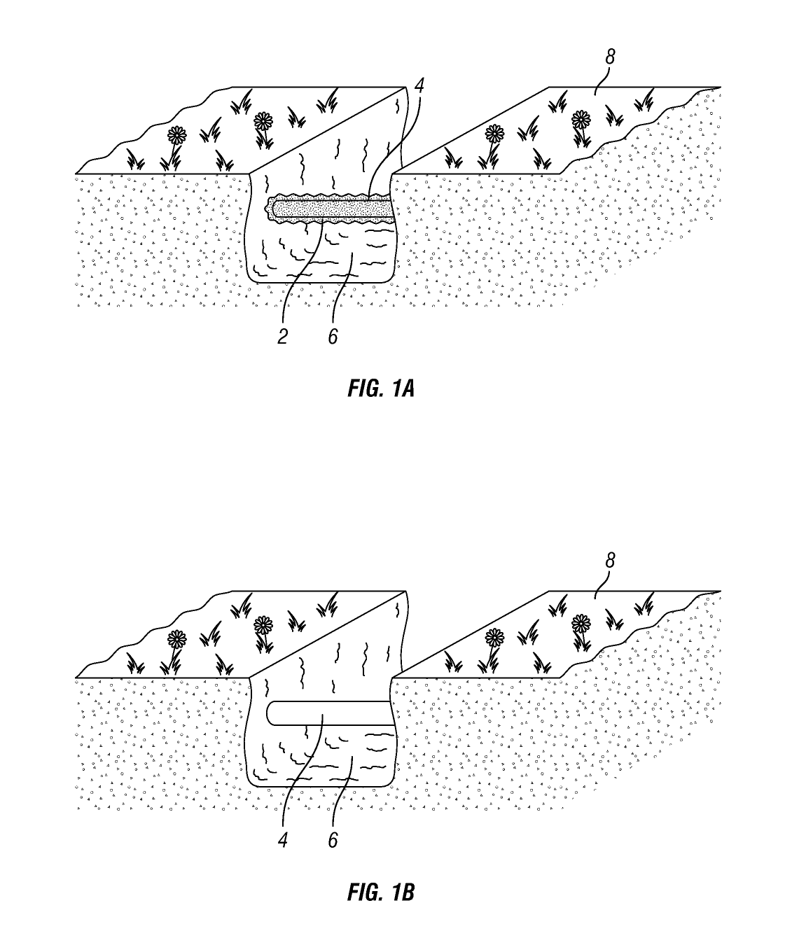

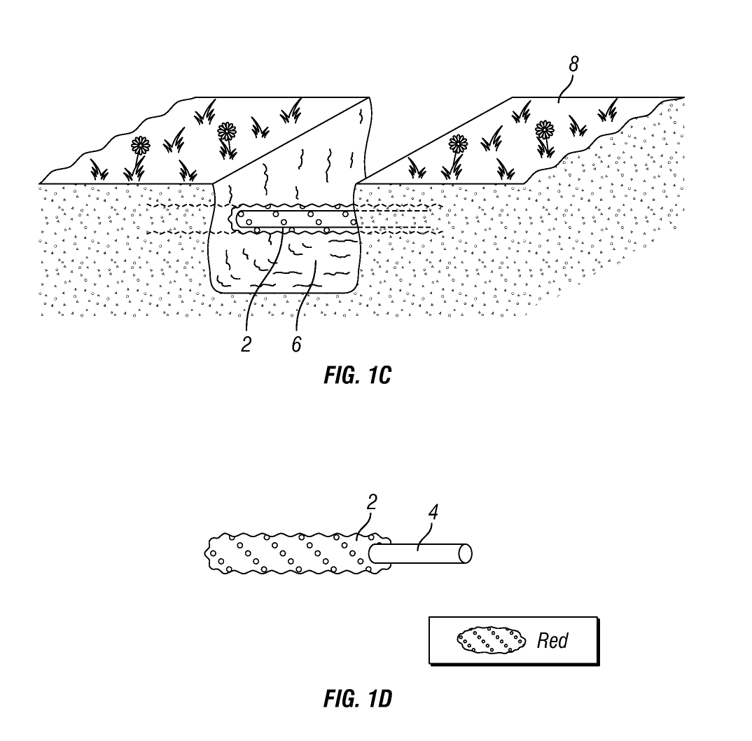

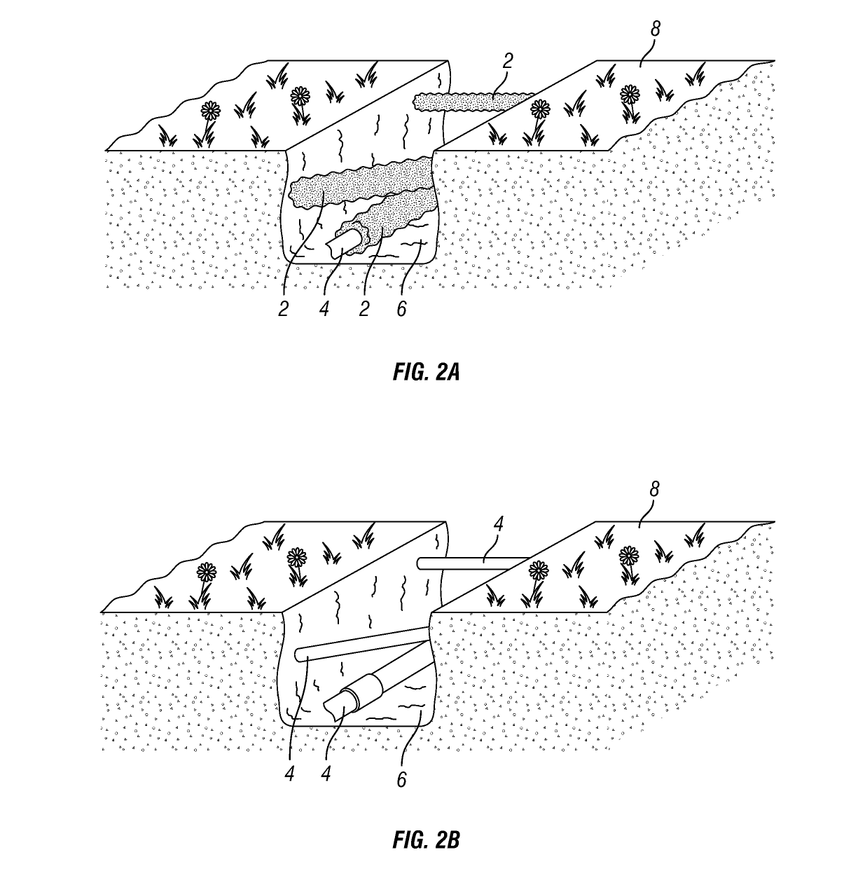

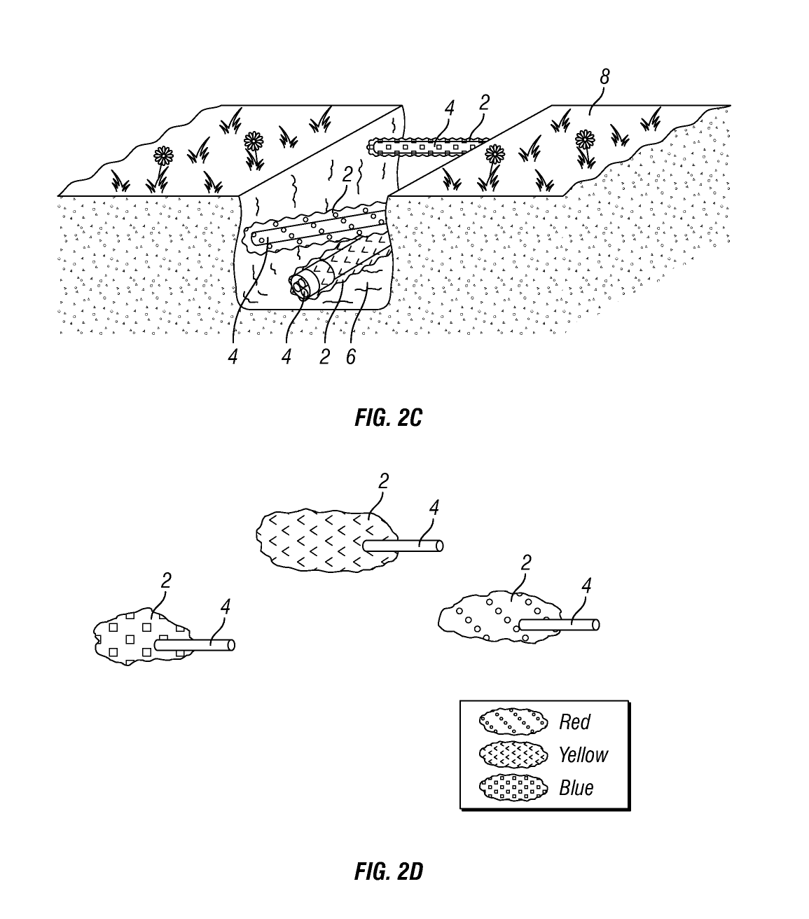

Referring to FIGS. 1A and 1B, a system and method used to detect and identify at least one utility line 4 is disclosed. In one embodiment, the system comprises an indicator 2 (shown in FIG. 1A) which may be applied to the outside surface of a utility line 4. FIG. 1B depicts a perspective view of a utility line 4 wherein indicator 2 has not yet been applied. In one example embodiment, the indicator 2 may be applied to the outside surface of an utility line 4 upon initial installation of the utility line 4. Referring now to FIGS. 2A and 2B, the system and method may be used to detect and identify a plurality of utility lines 4. Initial installation of one or more utility lines usually involves digging a trench 6 which requires starting with a purposed line of digging direction and finding all known utilities in the path. In order to locate and uncover existing utilities, hand digging may be used to find the depth and location. A tractor may then be used to dig a trench 6 to the governed depth as determined by utility companies to reach the end point of connection. Once the trench 6 has been created, the utility line 4 or conduit may be connected or rolled conduit may be unrolled until the end point is connected. In another embodiment, indicator 2 may be applied to one or more utility lines 4 at any point after initial installation when the utility line(s) 4 is exposed.

Referring to FIGS. 1A and 2A, in one embodiment, the indicator 2 may be a polyurethane foam applied to the outside surface of a utility line 4 with a pistol style applicator or extinguisher. The foam may be applied with any other type of spray apparatus or any application apparatus as desired by one of skill in the art. In one embodiment, the polyurethane foam may consist in liquid form as stored in the applicator. In another embodiment, upon application, the polyurethane foam may expand around a majority of the outside surface of utility line 4. In another embodiment, upon application, the polyurethane foam may expand around the entire outside surface of utility line 4. In a further embodiment, the polyurethane foam hardens while it expands to create a protective barrier around the outside surface of the utility line 4. Once the polyurethane foam expands and hardens, the utility line is buried underground.

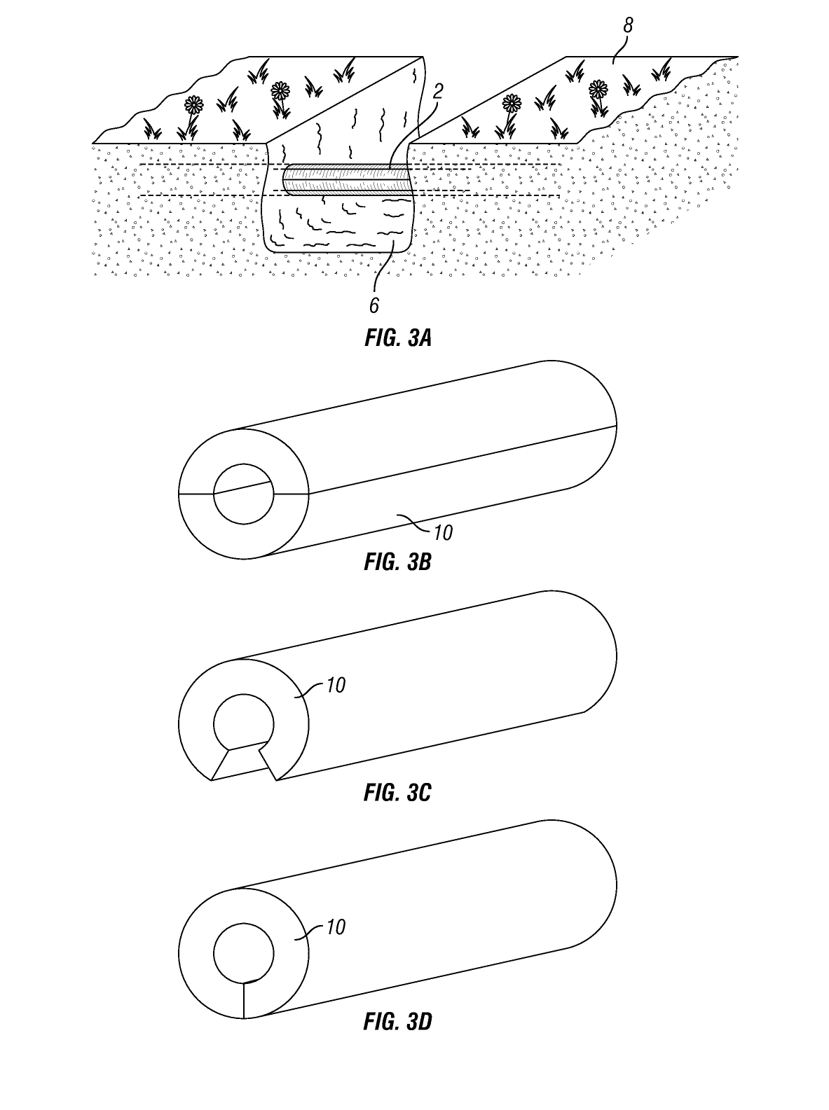

Referring now to FIGS. 3A to 3D, in another embodiment, the indicator may be a sleeve 6. Sleeve 6 may comprise a prefabricated foam that is able to be assembled around the utility line 4 or conduit after such utility line 4 is installed or exposed. Sleeve 6 creates a protective barrier around the outside surface of utility line 4. In one embodiment, sleeve 6 may be one continuous cylindrical casing with a hollow center capable of receiving a utility line 4 as shown in FIGS. 3C and 3D. The width of sleeve 6 will be dependent on the width of utility line 4 needed to be protected. Lee, can you give an example of specifications such as diameter of sample conduit and diameter of inner circle and outer circle of sleeve? In another embodiment, sleeve 6 may comprise two symmetrical portions that form a cylindrical casing with a hollow center capable of receiving a utility line 4 as shown in FIG. 3B. The two symmetrical portions may be attached with an adhesive. Other examples of indicators 2 that create a protective barrier around utility line 4 may be used as desired by one of skill in the art.

Referring now to FIGS. 1C, 1D, 2C and 2d, in one embodiment, indicator 2 applied to the utility line 4 may be a particular color depending on the type of utility line 4. In one embodiment, the particular color of indicator 2 corresponds with the utility color codes used in construction areas to temporarily identify the approximate location of existing underground utilities. The American Public Works Association (APWA) Uniform Color Codes for temporary marking of underground utilities is the following: red is used to mark electric power lines, cables, conduit and lighting cables; orange is used to mark telecommunication, alarm or signal lines, cables, or conduit; yellow is used to mark natural gas, oil, steam, petroleum, or other gaseous or flammable material; green is used to mark sewers and drain lines; blue is used to mark drinking water; violet is used to mark reclaimed water, irrigation, and slurry lines; pink is used to mark temporary survey markings, unknown/unidentified facilities; and white is used to mark proposed excavation limits or route.

For example, if indicator 2 is applied to the outside surface of electric power line 4, indicator 2 may be red. Indicator 2 may be allowed to expand and harden around a majority of the outside surface of electric power line 4. Power line 4 would subsequently be buried underground 8. In the future, when the location of such power line needs to be located, the digger would start digging and optimally begin seeing pieces of red indicator 2 before coming into actual contact with power line 4. As another example, if indicator 2 is applied to the outside surface of drinking water conduit 4, indicator 2 may be blue. Indicator 2 may be allowed to expand and harden around a majority of the outside surface of drinking water conduit 4. Drinking water conduit 4 would then be buried underground 8. In the future, when the location of drinking water conduit 4 needs to be located, the digger would start digging and optimally begin seeing pieces of blue indicator 2 before coming into actual contact with drinking water conduit 4.

In one embodiment, indicator 2 may be a particular color upon application. In another embodiment, indicator 2 may be a neutral color or light shade of color upon application and may change colors or change shades of color as indicator 2 dries and expands around the outside surface of the utility line. Such change in color of indicator 2 may also indicate that indicator 2 has hardened and has created a protective barrier around utility line 4.

Referring to FIGS. 1A, 1C, 1D, 2A, 2C and 2D, in a one embodiment, indicator 2 may expand about one inch around the majority of the outside surface of the utility line 4. In one embodiment, indicator 2 may expand at least one inch around and away from a majority of the outside surface of the utility line to create a protective barrier for the utility line. In another embodiment, indicator 2 may expand six to eight inches around and away from a majority of the outside surface of utility line 4. The length of expansion of indicator 2 away from a majority of the outside surface of utility line 4 may depend on the diameter of utility line 4. Any length of expansion of indicator 2 may be used to create a protective barrier around utility line 4 as desired by one of skill in the art. Once the polyurethane foam has expanded and hardened, utility line 4 with applied indicator 2 may be buried underground. In one embodiment, polyurethane foam may harden in five minutes. In another embodiment, polyurethane foam may harden anywhere from five minutes to one hour. Any amount of time may be used to allow polyurethane foam to harden as desired by one skilled in the art.

A method used to detect and identify at least one utility line 4 is also disclosed. In one embodiment, the method comprises the following steps: (a) applying an indicator 2 to the outside surface of the utility line 4 and (b) burying the utility line 4 underground. In one embodiment, step (a) comprises applying an indicator 2 comprising a polyurethane foam. In another embodiment, step (a) comprises applying an indicator 2 comprising a sleeve. Any other indicator 2, may be used as desired by one of skill in the art.

Referring to FIGS. 1A and 2A, in one embodiment, the indicator 2 may be a polyurethane foam applied to the outside surface of a utility line 4 with a pistol style applicator or extinguisher. The foam may be applied with any other type of spray apparatus or any application apparatus as desired by one of skill in the art. In one embodiment, the polyurethane foam may consist in liquid form as stored in the applicator. In another embodiment, upon application, the polyurethane foam may expand around a majority of the outside surface of utility line 4. In another embodiment, upon application, the polyurethane foam may expand around the entire outside surface of utility line 4. In a further embodiment, the polyurethane foam hardens while it expands to create a protective barrier around the outside surface of the utility line 4. Once the polyurethane foam expands and hardens, the utility line is buried underground.

Referring now to FIGS. 3A to 3D, in another embodiment, the indicator may be a sleeve 6. Sleeve 6 may comprise a prefabricated foam that is able to be assembled around the utility line 4 or conduit after such utility line 4 is installed or exposed. Sleeve 6 creates a protective barrier around the outside surface of utility line 4. In one embodiment, sleeve 6 may be one continuous cylindrical casing with a hollow center capable of receiving a utility line 4 as shown in FIGS. 3C to 3D. The width of sleeve 6 will be dependent on the width of utility line 4 needed to be protected. In another embodiment, sleeve 6 may comprise two symmetrical portions that form a cylindrical casing with a hollow center capable of receiving a utility line 4 as shown in FIG. 3B. The two symmetrical portions may be attached with an adhesive. Other examples of indicators 2 that create a protective barrier around utility line 4 may be used as desired by one of skill in the art.

Referring now to FIGS. 1C, 1D, 2C and 2D, in one embodiment, indicator 2 applied to the utility line 4 may be a particular color depending on the type of utility line 4. In one embodiment, the particular color of indicator 2 corresponds with the APWA Utility Color Codes used in construction areas to temporarily identify the approximate location of existing underground utilities. The APWA Utility Color Codes were set forth above. For example, if indicator 2 is applied to the outside surface of electric power line 4, indicator 2 may be red. Indicator 2 may be allowed to expand and harden around a majority of the outside surface of electric power line 4. Power line 4 would subsequently be buried underground 8. In the future, when the location of such power line needs to be located, the digger would start digging and optimally begin seeing pieces of red indicator 2 before coming into actual contact with power line 4. As another example, if indicator 2 is applied to the outside surface of drinking water conduit 4, indicator 2 may be blue. Indicator 2 may be allowed to expand and harden around a majority of the outside surface of drinking water conduit 4. Drinking water conduit 4 would then be buried underground 8. In the future, when the location of drinking water conduit 4 needs to be located, the digger would start digging and optimally begin seeing pieces of blue indicator 2 before coming into actual contact with drinking water conduit 4.

In one embodiment, indicator 2 may be a particular color upon application. In another embodiment, indicator 2 may be a neutral color or light shade of color upon application and may change colors or change shades of color as indicator 2 dries and expands around the outside surface of the utility line. Such change in color of indicator 2 may also indicate that indicator 2 has hardened and has created a protective barrier around utility line 4.

Referring to FIGS. 1A, 1C, 1D, 2A, 2C and 2D, in a one embodiment, indicator 2 may expand about one inch around the majority of the outside surface of the utility line 4. In one embodiment, indicator 2 may expand at least one inch around and away from a majority of the outside surface of the utility line to create a protective barrier for the utility line. In another embodiment, indicator 2 may expand six to eight inches around and away from a majority of the outside surface of utility line 4. The length of expansion of indicator 2 away from a majority of the outside surface of utility line 4 may depend on the diameter of utility line 4. Any length of expansion of indicator 2 may be used to create a protective barrier around utility line 4 as desired by one of skill in the art. Once the polyurethane foam has expanded and hardened, utility line 4 with applied indicator 2 may be buried underground. In one embodiment, polyurethane foam may harden in five minutes. In another embodiment, polyurethane foam may harden anywhere from five minutes to one hour. Any amount of time may be used to allow polyurethane foam to harden as desired by one skilled in the art.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

1. A system used to detect and identify at least one utility line comprising:
an indicator applied to the outside surface of a utility line, wherein the indicator surrounds at least a majority of the outside surface of the utility line, wherein the indicator creates a protective barrier around at least a majority of the outside surface of the utility line.

2. The system of claim 1, wherein the indicator comprises a polyurethane foam, wherein the foam upon application to the outside surface of the utility line expands around at least a majority of the outside surface of the utility line.

3. The system of claim 1, wherein the indicator is a sleeve.

4. The system of claim 1, wherein the indicator applied to the utility line is color coded dependent on the type of utility line.

5. The system of claim 2, wherein the indicator expands about at least one inch around at least a majority of the outside surface of the utility line.

6. The system of claim 1, wherein the indicator is applied to the outside surface of the utility line upon installation of the utility line.

7. The system of claim 1, wherein the indicator is applied to the outside surface of the utility line upon exposure of the utility line.

8. A system used to identify a plurality of utility lines comprising:
an indicator applied to the outside surface of each of the plurality of utility lines, wherein the indicator surrounds at least a majority of the outside surface of each of the utility lines, wherein the indicator creates a protective barrier around at least a majority of the outside surface of each of the utility lines.

9. The system of claim 8, wherein the indicator comprises a polyurethane foam, wherein the foam upon application to the outside surface of the utility lines expands around at least a majority of the outside surface of each of the utility lines.

10. The system of claim 8, wherein the indicator is a sleeve.

11. The system of claim 8, wherein the color of the indicator applied to each of the plurality of utility lines is color coded, dependent on the type of utility line.

12. The system of claim 9, wherein the indicator expands about at least one inch around at least a majority of the outside surface of the utility lines.

13. The system of claim 8, wherein the indicator is applied to the outside surface of each of the plurality of utility lines upon installation of the utility lines.

14. The system of claim 8, wherein the indicator is applied to the outside surface of each of the plurality of utility lines upon exposure of the utility lines.

15. A method used to detect and identify at least one utility line, the method comprising:
a.) applying an indicator to the outside surface of an at least one utility line, wherein the indicator surrounds at least a majority of the outside surface of the utility line, wherein the indicator creates a protective barrier around at least a majority of the outside surface of the utility line; and
b.) burying the utility line underground.

16. The method of claim 15, wherein step (a) comprises applying an indicator comprising a polyurethane foam which upon application expands at least a majority of the outside surface of the utility line.

17. The method of claim 15, wherein step (a) comprises applying an indicator comprising a sleeve.

18. The method of claim 15, wherein the indicator applied to the utility line in step (a) is color coded dependent on the type of utility line.

19. The method of claim 16, wherein the indicator in step (a) expands about at least one inch around a majority of the outside surface of the utility line.
